(19) United States
(12) Patent Application Publication
(10) Pub. No.: US 2009/0002797 A1
(43) Pub. Date: Jan. 1, 2009

(54) Multi-directional camera for a mobile device

(76) Inventors: Wah Yiu Kwong, Beaverton, OR (US); Hong W. Wong, Portland, OR (US)

Correspondence Address: SCHUBERT, OSTERRIEDER & NICKELSON, PLLC;c/o Intellevate, LLC, P.O. BOX 52050, MINNEAPOLIS, MN, 55402, US

(21) Appl. No.: 11/823,168

(22) Filed: Jun. 27, 2007

(51) Int. Cl. G02B 26/08; H04N 5/238

(52) U.S. Cl. 359/225; 348/369; 348/E05.04

(57) ABSTRACT

Systems and methods for providing a multi-directional camera for a mobile device are disclosed. Embodiments of a system may include a mobile device having a chassis and a multi-directional camera attached to the mobile device. The camera may include two or more camera lenses pointing in different directions and an image sensor substantially perpendicular to an image sensor axis. Embodiments may also include a mirror to redirect light from a camera lens to the image sensor where the mirror is tilted with respect to the image sensor axis and a rotating mechanism attached to the chassis to rotate the mirror from a first position to a second position, the first position resulting in light being redirected from a first lens to the imaging sensor and the second mirror position resulting in light being redirected from a second lens to the imaging sensor. Other embodiments are disclosed and claimed.

### FIELD

Embodiments are in the field of camera systems. More particularly, embodiments are in the field of camera systems for mobile computer systems and other electronic systems.

### BACKGROUND

Users of mobile computer systems such as ultra-mobile personal computers (UMPC) or laptop computer systems often desire to have the capability to capture still images or video with their computer system to take photographs or record videos for either business or pleasure. Cameras for mobile computer systems are particularly popular for business applications where they may be used in wide variety of applications such as videoconferencing, taking photographs for creating business records, or capturing product video. Cameras may either be after-market cameras that are separate from the mobile computer system or integrated into the mobile computer system. Integrated cameras are becoming more popular because of the increasing customer desire for integration, ease of use, and their lower profile.

Often, a user may desire to capture images in more than one direction, such as by having one camera facing towards the user during normal operation (e.g., for videoconferencing) and one camera facing outwards from the user (e.g., for shooting photographs or videos). One solution to this customer need is to have two separate cameras, such as by having one camera with its lens facing the user (for videoconferencing) and a second camera with its lens facing the opposite direction (for recording images in the field of view of the user). This solution, however, requires the size, complexity, and expense of having two separate cameras (including lens, imaging sensor, circuitry, etc.). Another solution would be to have one camera that rotates the entire camera so that the lens points in the direction desired. This solution requires a relatively large and complex mechanism to rotate the entire camera assembly. The large, rotating camera assembly may result in a complex mechanical design and may also severely limit the design options, such as by necessitating thicker and bulkier components (e.g., the laptop screen panel must be thicker to accommodate rotating mechanism). As cameras are used for additional and more varied purposes, there is increased need for cameras that are less expensive, physically smaller, or have improved functionality. An effective and efficient mechanism for providing multi-directional cameras may result in increased applications for cameras in mobile devices.

### BRIEF DESCRIPTION OF THE DRAWINGS

Aspects of various embodiments will become apparent upon reading the following detailed description and upon reference to the accompanying drawings in which like references may indicate similar elements:

FIGS. 1A-1C depict schematic front, back, and top views, respectively, of a mobile device with a multi-directional camera according to various embodiments;

FIGS. 2A-2B depict schematic partial side views of a mobile device with a multi-directional camera with the mirror in different positions according to various embodiments;

FIG. 3 depicts a schematic partial top view of a mobile device with a multi-directional camera with a mirror and rotation mechanism according to various embodiments; and

FIG. 4 depicts a flow diagram illustrating a method for capturing an image with a multi-directional camera according to various embodiments.

### DETAILED DESCRIPTION OF EMBODIMENTS

The following is a detailed description of embodiments of the invention depicted in the accompanying drawings. The embodiments are introduced in such detail as to clearly communicate the invention. However, the embodiment(s) presented herein are merely illustrative, and are not intended to limit the anticipated variations of such embodiments; on the contrary, the intention is to cover all modifications, equivalents, and alternatives falling within the spirit and scope of the appended claims.

Various embodiments of the present invention provide systems and methods for providing a multi-directional camera for a mobile device. The following description provides specific details of certain embodiments of the invention illustrated in the drawings to provide a thorough understanding of those embodiments. It should be recognized, however, that the present invention can be reflected in additional embodiments and may be practiced without some of the details in the following description. In other instances, well-known structures and functions have not been shown or described in detail to avoid unnecessarily obscuring the description of the embodiments. While specific embodiments will be described below with reference to particular configurations and systems, those of skill in the art will realize that the disclosed embodiments may advantageously be implemented with other substantially equivalent configurations and/or systems.

Generally speaking, systems and methods for providing a multi-directional camera for a mobile device are disclosed. Some embodiments may include a system with a mobile device having a chassis substantially enclosing components of the mobile device and a multi-directional camera attached to the mobile device. The multi-directional camera may include two or more camera lenses pointing in different directions and an image sensor substantially perpendicular to an image sensor axis. Embodiments may also include a mirror to redirect light from a camera lens to the image sensor where the mirror is tilted with respect to the image sensor axis. The multi-directional camera may also include a rotating mechanism attached to the chassis to rotate the mirror from a first position to a second position, the first position resulting in light being redirected by the mirror from a first lens to the imaging sensor and the second mirror position resulting in light being redirected by the mirror from a second lens to the imaging sensor.

Other embodiments include a method for providing a multi-directional camera. The method may include receiving a request to capture an image and an indication of a desired camera direction when capturing the image. The method may also include transmitting a command to rotate a mirror from a first position associated with a first camera lens facing a first direction to a second position associated with a second, different camera lens facing the desired camera direction. The method may also include, after the mirror has rotated to the second position, capturing an image passing through the second, different camera lens and redirected by the mirror.

The disclosed systems and methods may provide for an effective and efficient multi-directional camera for mobile devices. As will be described in more detail subsequently, the disclosed system may rotate a mirror between positions to facilitate using separate camera lenses with a single imaging sensor. By only having to move only the mirror instead of an entire camera to achieve multiple directions of imaging capability, the disclosed system may in some embodiments result in lower system cost, lower power consumption, lower weight, simpler mechanical design, and smaller form factor. These results may prove particularly beneficial for ultra-mobile systems that are especially cost-sensitive and where size and weight are at a premium.

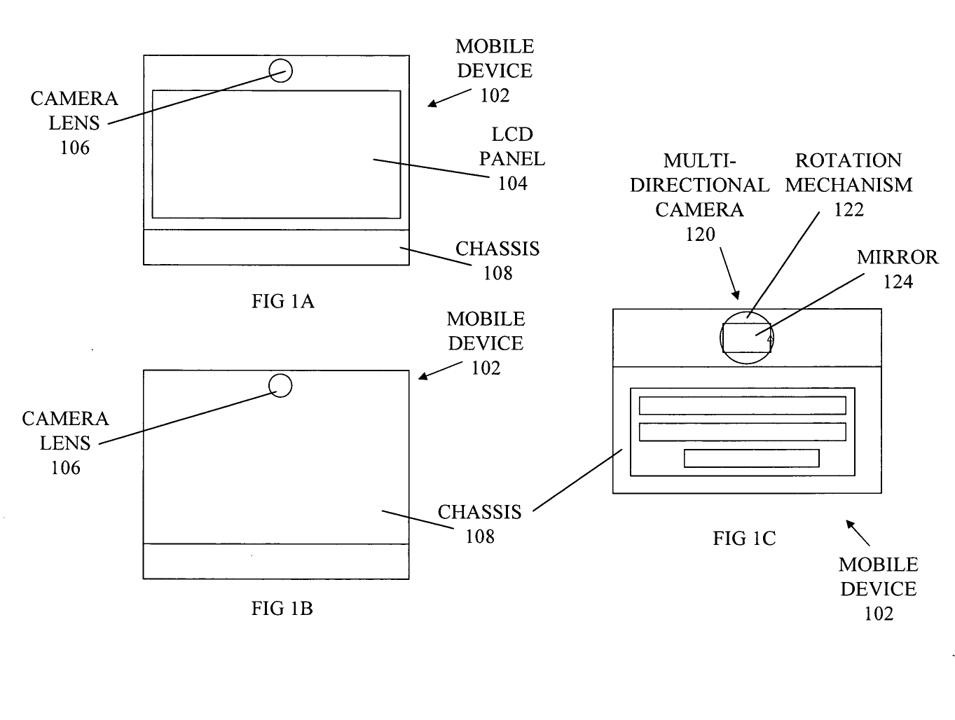

FIGS. 1A, 1B, and 1C depict schematic front, back, and top views, respectively, of a mobile device with a multi-directional camera according to various embodiments. FIGS. 1A-1C, which are not to scale, depict a mobile device 102 with an LCD panel 104. The mobile device 102 may have a chassis 108 substantially enclosing some components of the mobile device 102. The LCD panel 104 may be used to display information to a user and may thus be visible through the chassis 108.

The mobile device 102 of the disclosed embodiments may be any mobile computing device, such as a portable personal computer (PC), notebook or laptop computer, PDAs, mobile phones, wireless devices, ultra-mobile PC (UMPC), tablet PC, Global Position System (GPS) receiver, wearable computer, or other mobile computing device. The mobile device 102 may typically include components mounted on a multi-layer planar or motherboard (which may itself be mounted on the chassis 108) to provide a means for electrically interconnecting the components. The mobile device 102 may include components such as a processor, storage, memory, a user interface adapter, etc. connected to a bus or other interconnect.

The processor may include one or more system central processing units (CPUs) or processors to execute instructions, such as an IBM® PowerPC™ processor, processors from Intel corporation (such as an Intel® Pentium® processor, an Intel® Itanium® 2 processor, an Intel® Xeon® processor), an Advanced Micro Devices Inc. processor or any other suitable processor. The processor may utilize storage, which may be non-volatile storage such as one or more hard drives, tape drives, diskette drives, CD-ROM drive, DVD-ROM drive, or the like. The processor may also be connected to memory via a memory controller hub (MCH), and system memory may include volatile memory such as random access memory (RAM) or double data rate (DDR) synchronous dynamic random access memory (SDRAM).

The mobile device 102 of FIGS. 1A-1C also includes two separate camera lenses 106. The camera lenses 106 may be attached to or integrated into the mobile device chassis 108. Any type of lens may be utilized for camera lens 106, such as a glass lens, plastic lens, Fresnel zone lens, or pinhole. A first camera lens 106 is depicted above the LCD panel 104 of the front view of FIG. 1A. The camera lens 106 of FIG. 1A may face forward towards the expected operator position of the user of the mobile device 102 and may thus be used for videoconferencing or other application for which an image of the user is utilized during operation of the mobile device 102. The camera lens 106 of FIG. 1B may face away from the expected operator position and be positioned on the back side of the chassis 108. The camera lenses of FIGS. 1A and 1B may thus face in opposite directions, one facing the user and the other facing away from the user.

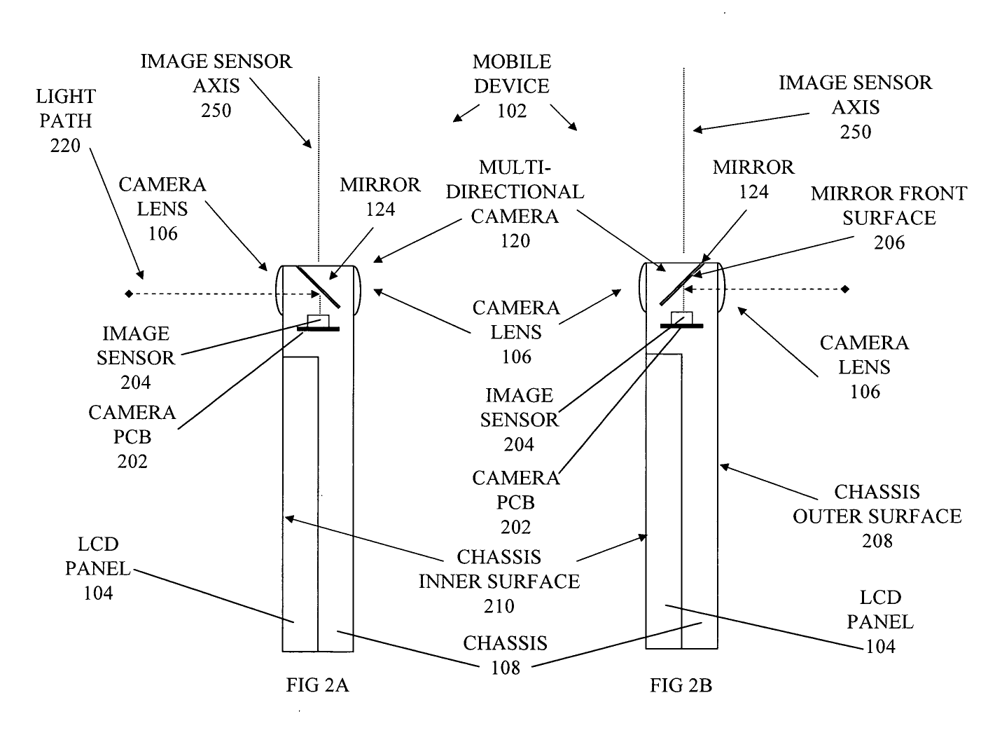

As will be described in more detail, the multi-directional camera 120 of FIG. 1C may be attached to the mobile device 102 and may utilize either of the camera lenses 106 to capture images. By rotation of a rotation mechanism 122, a mirror 124 within the multi-directional camera 120 may also be rotated. The mirror 124, when properly positioned, may redirect light forming an image from one of the camera lenses 106 to an imaging sensor (not shown but depicted in relation to FIG. 2) of the multi-directional camera 120. The mirror 124 may redirect the light path by a tilt of the mirror 124 at an angle that sufficient redirects light impacting it towards the imaging sensor. In the depicted embodiment, the mirror 124 may be positioned at a first position to redirect light from the camera lens 106 on the front of the mobile device 102 and may be positioned at a second position to redirect light from the camera lens 106 on the back of the mobile device 102. In such fashion, the multi-directional camera 120 may capture images in the direction of each camera lens 106 by moving the rotation mechanism 122 (and thus the mirror 124) to positions associated with each camera lens 106.

The rotation mechanism 122 may be any device adapted to rotate upon receiving a command and may in some embodiments be a round or cylindrical mechanical structure that rotates 180 degrees or more about a central axis. The rotation mechanism 122 may be driven by an electrical or other motor to perform its rotation. The mirror 124 may be any object that is at least partially reflective on one surface and preferably includes a substantially flat mirrored surface to redirect light received from a camera lens 106. A triangular prism may also be used as mirror 124.

FIGS. 2A and 2B depict schematic partial side views of a mobile device with a multi-directional camera with the mirror in different positions according to various embodiments. FIGS. 2A and 2B may include components or features similar to that of FIGS. 1A-1C and the description will not be repeated in the interest of brevity. FIGS. 2A and 2B, which are not to scale, depict a cut-away mobile device 102 with an LCD panel 104 and a multi-directional camera 120 positioned near the top of the mobile device 102 above the LCD panel 104.

The multi-directional camera 120 may include an image sensor 204 to record images based on light received at the image sensor 204. Image sensor 204 of the multi-directional camera 120 may be positioned such that its receiving surface is substantially flat and perpendicular to an image sensor axis 250. In the depicted embodiment, the image sensor axis 250 is parallel the viewing surface of the LCD panel 104 and perpendicular to the entry path of the light path 220 as it enters the camera lenses 106. Image sensor 204 may be any type of optical sensor that may capture an indication of an image, such as a charge-coupled device (CCD) sensor, complementary metal-oxide-semiconductor (CMOS) sensor, or other type of sensor. Alternatively, image sensor 204 may use film instead of a digital imaging array. The image sensor 204 may be optionally positioned on a camera printed circuit board (PCB) 202 that provides for operation and control of the image sensor 204, including capturing, processing, and storing images.

Beginning with FIG. 2A, a side view of the mobile device 102 illustrates the two, opposite-facing camera lenses 106 located above the LCD panel 104. The leftmost camera lens 106 is depicted at the chassis inner surface 210 and the rightmost camera lens 106 is depicted at the chassis outer surface 208. The light path 220 from outside the mobile device 102 and through the camera lens 106 is depicted. The light path 220 of FIG. 2A passes through the camera lens 106 facing the user (i.e., leftmost camera lens 106 in FIG. 2A) and strikes mirror 124, which in turn redirects the light path 220 toward the imaging sensor 204.

Mirror 124 may be positioned to deflect incoming light from a camera lens 106 to the image sensor 204, thus making it required in many embodiments to redirect the incoming light to the image sensor 204. In some embodiments, image sensor 204 performance is enhanced if incoming light strikes it perpendicular to the image sensor 204 surface. To accomplish the redirection, the mirror 124 may typically be tilted with respect to the receiving surface of the image sensor 204 as well as being tilted with respect to the central axis of the camera lens 106 so that the light is redirected accordingly. The mirror front surface 206 may be composed of or coated with at least partially reflective material so as to reflect at least a portion of incoming light.

In the depicted embodiment, mirror 124 is tilted leftward (i.e., towards the leftmost camera lens 106) at an angle of approximately 45 degrees from vertical. At this angle, the mirror 124 may redirect light from the horizontal (through camera lens 106) to the image sensor 204 directly below the mirror 124. The mirror 124 may thus “turn” the light path 220 a full 90 degrees to redirect the light to the image sensor 204. While the depicted embodiment includes the mirror 124 at 45 degrees to redirect the light path 220 by 90 degrees, one of ordinary skill in the art will recognize that other configurations are possible and that the angle of tilt of the mirror 124 may need to change accordingly.

FIG. 2B depicts the mobile device 102 and multi-directional camera 120 of FIG. 2A with the mirror 124 repositioned to work with the other, rightmost camera lens 106. With respect to the mirror 124 position of FIG. 2A, the mirror 124 of FIG. 2B is rotated 180 degrees about the image sensor axis 250 so that it is facing in the opposite direction. In this new position, the mirror 124 may redirect light path 220 from the rightmost camera lens 106 to the image sensor 204. After the mirror 124 is rotated, it will be tilted rightward in the view of FIG. 2B (i.e., towards the rightmost camera lens 106) so that its mirror front surface 206 faces the second camera lens 106. The rotation of the mirror 124 (as performed by the rotation mechanism 122, not depicted in FIGS. 2A and 2B) may provide for a single image sensor 204 to receive images for capture from multiple camera lenses 106 by rotating the mirror 124 to the appropriate positions.

While the multi-directional camera 120 is depicted as having two, opposite-facing camera lenses 106, one of ordinary skill in the art will recognize that the disclosed system will also facilitate the use of three or more camera lenses 106. The number of camera lenses 106, and their relative geometry, will depend on the design of the mobile device 102 and the needs of customers of the mobile device 102. A laptop computer mobile device 102, for example, could have four separate camera lenses 106 facing in perpendicular directions and in the main part of the chassis 108 so that images can be captured from all four sides of the laptop computer. A cell phone mobile device 102, in contrast, may in some embodiments be limited to two camera lenses 106 because of the relative small size of the device. As lens technology continues to improve, however, as smaller and smaller lenses may be created, three or more camera lenses 106 may be also be used in multi-directional cameras 120 in smaller mobile devices 102.

Non-limiting example mobile devices with multi-directional cameras 120 may provide illustrative of various embodiments. An example described previously would be a laptop or UMPC with a multi-directional camera 120 that could capture images in two different directions. One camera lens 106 could point towards the user for use in videoconferencing and another camera lens 106 could face outwards so that the user could capture images behind the mobile device 102. In some embodiments, the user could switch between the two camera lenses 106 via software command (such as entered using a Graphical User Interface (GUI)), a physical button or switch on the mobile device 102, or means. In another non-limiting example, a handheld mobile device 102 such as a mobile phone or PDA could be equipped with multiple camera lenses 106 so that photographs could be taken in multiple directions by toggling the mirror position 124. In yet another non-limiting example, a notebook computer mobile device 102 may have four camera lenses 106 all facing in different directions so that the notebook computer could capture still or video images in four different directions without a user having to move the notebook computer. A user may find such a mobile device 102 useful, for example, to record video evidence at a site of a business accident and to ensure that sufficient images were taken from the appropriate angles.

By providing for multi-directional camera 120 capability without the need for multiple camera systems, the disclosed system may reduce system cost, size, complexity, and power consumption. Moreover, the disclosed multi-directional camera 120 may provide for easier industrial design as it may fit into a smaller space than other systems and thus has a smaller form factor (i.e., can be designed to be relatively thin and compact). The motor to drive the multi-directional camera may also be relatively small and quiet as it need only drive the mirror 124 (which is typically lightweight when compared to an entire camera) instead of having to drive an entire camera assembly.

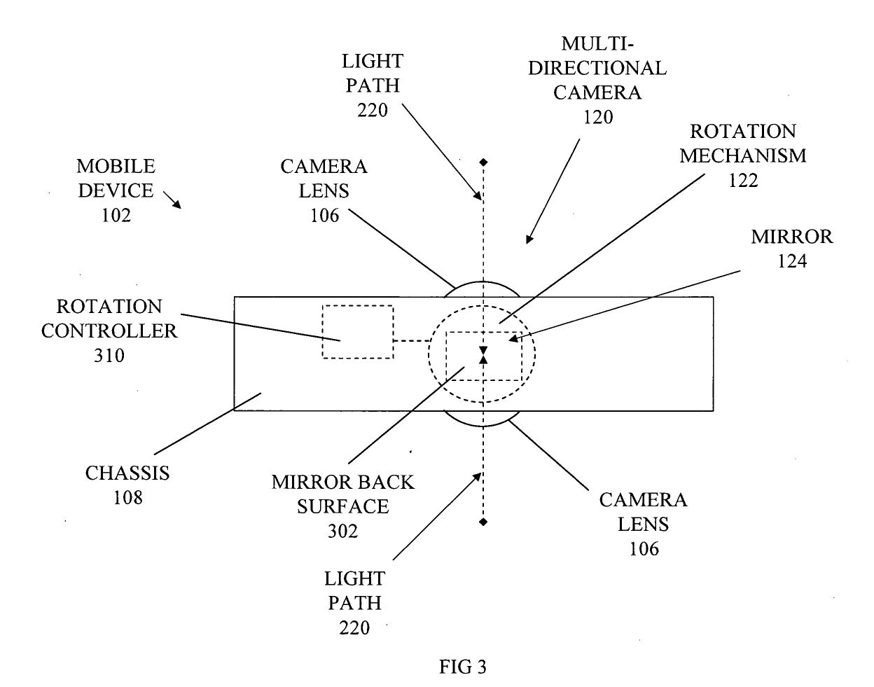

FIG. 3 depicts a schematic partial top view of a mobile device with a multi-directional camera with a mirror 124 and rotation mechanism 122 according to various embodiments. The mobile device 102 of FIG. 3 (which is not to scale) depicts two opposite-facing camera lenses 106 protruding from chassis 108. The rotation mechanism 122 of the multi-directional camera 120 may rotate the mirror 124 back and forth 180 degrees so as to be in position to alternately direct light from either of the two camera lenses 106, as described previously. The mirror back surface 302 is not the surface that is required to have reflective characteristics as it does not redirect light path 220. The mirror front surface 206 of FIGS. 2A and 2B redirects the light path 220 to the image sensor 204, as depicted in FIGS. 2A and 2B.

The rotation mechanism 122 may rotate the mirror 124 to the various positions necessary to capture images through the various camera lenses 106. In some embodiments, the mirror 124 may be directly attached to the rotation mechanism 122 such that the mirror 124 and rotation mechanism 122 rotate simultaneously. Some embodiments of the rotation mechanism may be a round mechanical structure that allows for rotation of up to 180 degrees in either direction (or 360 degrees in one or both directions of rotation). The rotation mechanism 122 may have a motor to drive part or all of the rotation mechanism 122 itself. In some embodiments, the rotation mechanism 122 may rotate to various mirror positions upon receiving a command from a rotation controller 310. The rotation mechanism 122 may also provide an indication of its current position in some embodiments.

The rotation mechanism 122 may rotate about one or more axes to move from one position to another. In one embodiment, the rotation mechanism 122 may rotate about the image sensor axis 250 as depicted in FIGS. 2A and 2B. In other embodiments, the rotation mechanism 122 may rotate about one or more other alternative axes, such as may be useful if design limitations necessitate different rotation envelopes.

A rotation controller 310 may command the rotation controller 122 to rotate to various positions. In one embodiment, the rotation controller 310 may receive a request from another component of the mobile device 102 to rotate to a particular position. In this embodiment, the rotation controller 310 may optionally translate such a request into an appropriate command for the rotation mechanism. The rotation controller 310, which is optional, may be integrated into the multi-directional camera 120 (such as being located on the camera PCB 202) or may be implemented separately. The rotation controller 310 may include hardware, firmware, and/or software to accomplish its tasks, and may also be implemented using any combination of discrete circuitry, application specific integrated circuits (ASICs), logic gates and/or single chip architectures. Alternatively, the functions of the rotation controller 310 may be implemented using microcontrollers, programmable logic arrays and/or microprocessors or any combination of the foregoing where suitably appropriate (collectively or individually referred to as “logic”). One of ordinary skill in the art will recognize that the rotation mechanism 122 and rotation controller 310 may be implemented in any fashion to accomplish the task of rotating the mirror 124.

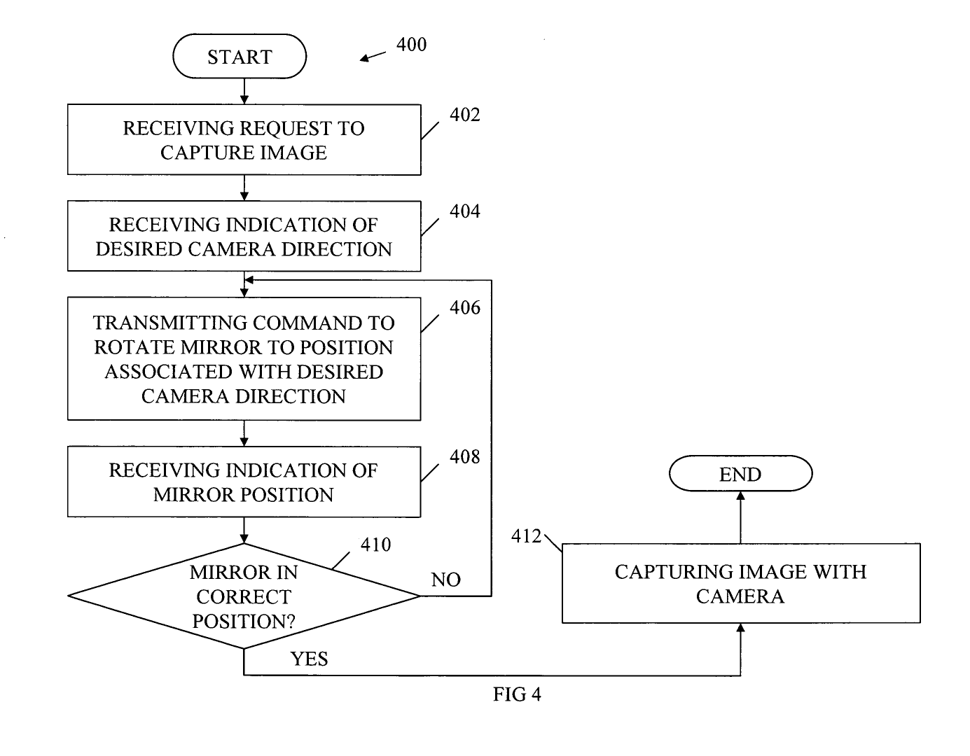

FIG. 4 depicts a flow diagram illustrating a method for capturing an image with a multi-directional camera 120 according to various embodiments. Some or all of the elements of method 400 may be performed by components of the multi-directional camera 120. Method 400 begins with element 402, receiving a request to capture an image. As described previously, the image may either be a still image (i.e., photograph) or video image (i.e., a series of still images). The multi-directional camera 120 may receive such a request from a mobile device 102, which in turn may be responding to a user request for an image. At element 404, the multi-directional camera 120 may receive an indication of a desired camera direction. The multi-directional camera 120 may receive such indication in any fashion, such as by receiving an indication of direction, an indication of a particular camera lens 106, or other indication. Elements 402 and 404 may be combined if a request includes both the request to capture the image as well as the desired camera direction.

At element 406, the rotation controller 310 may transmit a command to the rotation mechanism 122 to rotate to the position associated with desired camera direction. As described previously, rotation of the rotation mechanism 122 results in rotation of the mirror 124. If, for example, the indication of desired camera direction was a camera lens 106 identifier, the transmitted command may be to rotate the rotation mechanism 122 to the position associated with that particular camera lens 106. The rotation controller 310 may receive at optional element 408 an indication of the position of the mirror 124. If such an indication is received, the rotation controller 310 may determine at decision block 410 if the mirror 124 is in the correct position. If not, the method may return to element 406 to retransmit the command or perform other remedial action. The determination of whether the mirror is in the correct position may be delayed until the rotation mechanism 122 has had sufficient time to rotate into position.

Once the mirror 124 is in position, the multi-directional camera 120 may capture an image by recording the image striking the image sensor 204, after which the method terminates. As described previously, the mirror 124, once in position, redirects a light path 250 from the desired camera lens 106 to the image sensor 204. The method of flow chart 400 may be repeated for multiple captured images and the rotation of the mirror 124 to different camera lenses 106 may be performed as necessary. The disclosed method may therefore provide an effective methodology for using the multi-directional camera 120 to record or capture images through a plurality of camera lenses 106.

While certain operations have been described herein relative to a direction such as “above” or “below” it will be understood that the descriptors are relative and that they may be reversed or otherwise changed if the relevant structure(s) were inverted or moved. Therefore, these terms are not intended to be limiting.

It will be apparent to those skilled in the art having the benefit of this disclosure that the present invention contemplates systems and methods for providing a multi-directional camera 120 for a mobile device 102. It is understood that the form of the invention shown and described in the detailed description and the drawings are to be taken merely as examples. Although the present invention and some of its advantages have been described in detail for some embodiments, it should be understood that various changes, substitutions and alterations can be made herein without departing from the spirit and scope of the invention as defined by the appended claims. Accordingly the inventive embodiments are not limited by the specific disclosure above, but rather should be limited only by the scope of the appended claims and their legal equivalents. It is intended that the following claims be interpreted broadly to embrace all the variations of the example embodiments disclosed.

Although an embodiment may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

What is claimed is:

1. A system, comprising:
a mobile device having a chassis substantially enclosing components of the mobile device; and
a multi-directional camera attached to the mobile device, comprising:
two or more camera lenses pointing in different directions;
an image sensor substantially perpendicular to an image sensor axis;
a mirror to redirect light from a camera lens to the image sensor, the mirror being tilted with respect to the image sensor axis; and
a rotating mechanism attached to the chassis to rotate the mirror from a first position to a second position, the first mirror position resulting in light being redirected by the mirror from a first lens to the imaging sensor, and the second mirror position resulting in light being redirected by the mirror from a second lens to the imaging sensor.

2. The system of claim 1, wherein the multi-directional camera is integrated into the mobile device.

3. The system of claim 1, wherein the two or more camera lenses pointing in different directions comprise two camera lenses pointing in opposite directions.

4. The system of claim 2, wherein one of the two lenses points toward an expected user position.

5. The system of claim 1, wherein the two or more camera lenses pointing in different directions comprise two or more camera lenses integrated into the mobile device chassis.

6. The system of claim 1, wherein the mirror is attached to the rotating mechanism and rotates with the rotating mechanism.

7. The system of claim 1, wherein the mirror is tilted with respect to the image sensor axis at an angle of forty-five (45) degrees.

8. The system of claim 1, wherein the rotating mechanism is rotatably attached to the chassis substantially about the image sensor axis.

9. The system of claim 1, wherein the rotating mechanism is rotatably attached to the chassis substantially about an axis perpendicular to the image sensor axis.

10. The system of claim 1, wherein the rotating mechanism rotates to three or more different positions, each different position being associated with a different camera lens of the multi-directional camera.

11. A method, comprising:
receiving a request to capture an image and an indication of a desired camera direction when capturing the image;
transmitting a command to rotate a mirror from a first position associated with a first camera lens facing a first direction to a second position associated with a second, different camera lens facing the desired camera direction; and
after the mirror has rotated to the second position, capturing an image passing through the second, different camera lens and redirected by the mirror.

12. The method of claim 11, further comprising receiving an indication that the mirror has rotated to the second position.

13. The method of claim 11, wherein the first direction and the desired camera direction are opposite directions.

14. The method of claim 11, wherein the command to rotate the mirror comprises a command to rotate the mirror to one of three or more different positions, each different position being associated with a different camera lens.

15. The method of claim 11, wherein receiving a request to capture an image and an indication of a desired camera direction comprises receiving the request to capture the image separately from receiving the indication of the desired camera direction.
